(19) United States
(12) Patent Application Publication
(10) Pub. No.: US 2020/0355937 A1
(43) Pub. Date: Nov. 12, 2020

(54) EASY STORAGE GLASSES

(71) Applicant: Forrest Hollar, Augusta, GA (US)

(72) Inventor: Forrest Hollar, Augusta, GA (US)

(21) Appl. No.: 16/408,432

(22) Filed: May 9, 2019

(51) Int. Cl. G02C 5/22; G02C 5/14

(52) U.S. Cl. CPC G02C 5/2218; G02C 5/14

(57) ABSTRACT

A pair of reading glasses having a right side, a left side, a right lens, a left lens, a right temple, a left temple and a nose pad. The right temple is coupled to the right side of the frame of the reading glasses by a first hinge assembly. The left temple is coupled to the left side of the frame of the reading glasses by a second hinge assembly. The right lens and left lens are protected from rubbing or scrapping surfaces by the position of the right temple and the left temple effectively creating a self-made case for the reading glasses.

### FIELD OF THE INVENTION

This invention relates to glasses. More particularly, it relates to the storage of glasses.

### BACKGROUND

Many people have poor vision. When a person has poor vision, many times that person wears either contact lenses or glasses. Sometimes even if a person is not required to wear eyeglasses or contact lenses, he or she may choose to wear sunglasses to protect their eyes from solar rays or eyeglasses for aesthetic purposes. Many people that wear eyeglasses or sunglasses choose to store such eyeglasses and sunglasses in cases.

Eyeglasses and sunglasses cases have padding on the inside to prevent scratching of the lenses of either the eyeglasses or sunglasses. Such cases may be a hard case or a soft pouch that protects the lenses. In the past, such sunglasses or eyeglasses cases have been bulky or cumbersome. When a sunglasses or eyeglasses case is bulky, it may become difficult for a person to carry.

Because sunglasses or eyeglasses cases are difficult to carry, many times people do not use a sunglasses or eyeglasses case to protect the sunglasses or eyeglasses. Because of this, many times a person's sunglasses or eyeglasses can become lost or scratched. At times, a person is forced to store the sunglasses or eyeglasses in places not intended for storing or carrying sunglasses or eyeglasses, such as in a person's pocket or along a person's collar.

Another problem with existing eyeglasses cases or sunglasses cases is that many times a person may misplace or lose the case. When this happens, a person may be required to purchase an additional pair of sunglasses or eyeglasses and an additional case. This increases the cost of eye care.

Another problem with existing eyewear cases is that many times a person is unable to carry a piece of eyewear lens cleaning material or cloth inside of the case. Eyewear cases have a limited amount of space for carrying items. Many times, there is not enough space inside of a case to carry both a cleaning cloth and eyewear. Many times, a cleaning cloth haphazardly inserted into an eyewear case and can cause the eyewear to not properly fit inside the case, which may damage the eyewear.

Another problem with existing eyeglasses or sunglasses cases is that many times a person is unable to store such cases on their person. Many times, cases are too large to fit inside of a pants pocket or shirt pocket and as a result the person is unable to prevent scratching of the lenses of a pair of sunglasses or eyeglasses. As a result, based upon the all of the problems listed above, there is a need for improvement.

### BRIEF DESCRIPTION OF THE DRAWINGS

FIG. 1 is an illustrated exemplary pair of reading glasses.

FIG. 2 is an illustrated folded pair of the reading glasses of FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

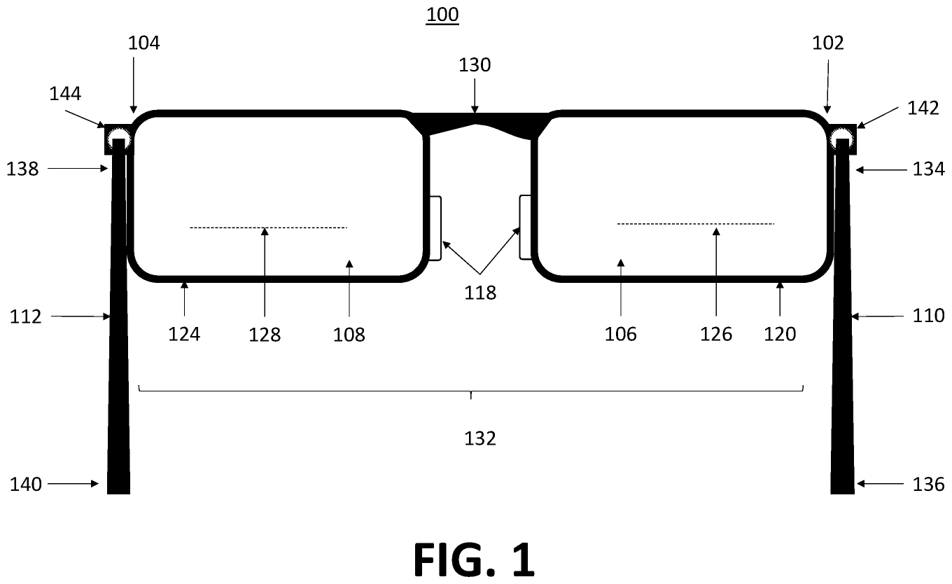

Referring to FIG. 1, an exemplary reading glasses (apparatus) 100 are illustrated. The glasses are useful for those people that do not want to get prescriptions or need a pair of glasses quickly. The pair of reading glasses 100 can be purchased at a retail store or may be prescribed by an optometrist. The reading glasses 100 are preferably made of plastic, but may be made of aluminum, steel, etc. The reading glasses 100 are generally light weight and easy to use.

The reading glasses 100 has a right side 102, a left side 104, a right lens 106, a left lens 108, a right temple 110, a left temple 112 and a nose pad 118.

The right side 102 of the reading glasses 100 has a right rim 120. The right rim 120 of the right side 102 of the reading glasses 100 securely holds the right lens 106. The right lens 106 may be made of glass, plastic, etc. The right lens 106 may be a single lens, a first bifocal lens 126, etc. The right lens 106 is preferably rectangular but may be any other shape that is configured to improve sight. Generally, the right lens 106 and the left lens 108 are preferably the same shape and material.

The left side 104 of the reading glasses 100 has a left rim 124. The left rim 124 securely holds the left lens 108. The left lens 108 may be made of glass, plastic, etc. The left lens 108 may be a single lens, a second bifocal lens 128, etc. The left lens 108 is preferably rectangular but may be any other shape that is configured to improve sight. Generally, the right lens 106 and the left lens 108 are preferably the same shape and material.

For ease and comfort, as well as helping to secure the reading glasses 100 to a user's nose, the nose pads 118 are located between the right and left rims and provide a pressure on the nose and secures the reading glasses 100 in place.

The reading glasses 100 further has a bridge 130. The bridge 130 is located between the right rim and the left rim and is useful to securely couple the right rim 120 and the left rim 124. The bridge 130 further is useful in securing the reading glasses 100 to an upper portion of the nose while the nose pads 118 are securing the reading glasses 100 to the nose.

The right rim 120, left rim 124, right lens 106, left lens 108, bridge 130, and nose pads 118 are collectively referred to as the frame 132.

The right temple 110 of the reading glasses 100 are coupled to the right side 102 of the frame 132 of the reading glasses 100. The right temple 110 has a proximal end 134 and a distal end 136. The right temple 110 is useful in securing the reading glasses 100 when worn by the user. The distal end 136 of the right temple 110 secures comfortably to a right ear of the user.

The left temple 112 of the reading glasses 100 are coupled to the left side 104 of the frame 132 of the reading glasses 100. The left temple 112 has a proximal end 138 and a distal end 140. The left temple 112 is useful in securing the reading glasses 100 when worn by the user. The distal end 140 of the left temple 112 secures comfortably to a left ear of the user.

The proximal end 134 of the right temple 110 is coupled the right side 102 of the frame 132 of the reading glasses 100. The right temple 110 is coupled to the right side 102 of the frame 132 of the reading glasses 100 by a first hinge assembly 142. The first hinge assembly 142 has two or more tension springs and screws to secure the first hinge assembly 142 to the proximal end 134 of the right temple 110 and the right side 102 of the frame 132 of the reading glasses 100. The two or more tension springs of the first hinge assembly 142 form a joint and are coupled on either side of the connection of the right side 102 of the frame 132 of the reading glasses 100 and the proximal end 134 of the right temple 110.

The proximal end 138 of the left temple 112 is coupled the left side 104 of the frame 132 of the reading glasses 100. The left temple 112 is coupled to the left side 104 of the frame 132 of the reading glasses 100 by a second hinge assembly 144. The second hinge assembly 144 has two or more tension springs and screws to secure the second hinge assembly 144 to the proximal end 138 of the left temple 112 and the left side 104 of the frame 132 of the reading glasses 100. The two or more tension springs of the second hinge assembly 144 form a joint and are coupled on either side of the connection of the left side 104 of the frame 132 of the reading glasses 100 and the proximal end 138 of the left temple 112.

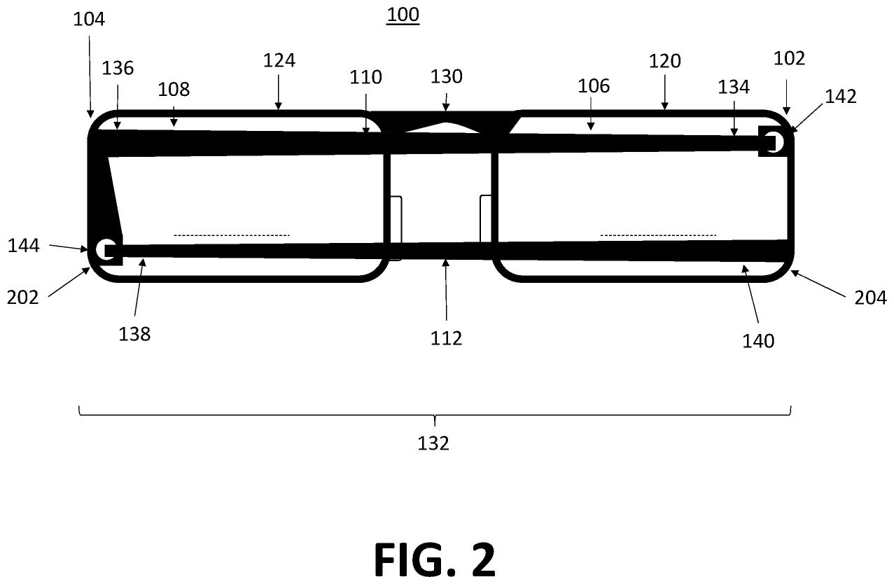

Moving now to FIG. 2, the reading glasses 100 of FIG. 1 is illustrated in a closed position. The closed position of the reading glasses 100 is useful to prevent the right lens 106 and/or the left lens 108 from being scratched by becoming engaged with a surface.

The right temple 110 is communicably coupled to the right side 102 of the frame 132 of the reading glasses 100. The coupling of the proximal end 134 of the right temple 110 to the right side 102 of the frame 132 of the reading glasses is performed by the hinge assembly 142. The hinge assembly 142 have two or more tension springs where the tension springs of the hinge assembly 142 form a joint.

The right temple 110 is bent at the first hinge assembly 142. The joint formed by the tension springs of the first hinge assembly 142 is configured such that the right temple 110 crosses over the frame 132 of the reading glasses 100. The proximal end 134 of the right temple 110 is configured at the right side 102 of the frame 132 of the reading glasses 100. The distal end 136 of the right temple 110 is configured at the left side 104 of the frame 132 of the reading glasses 100.

The left temple 112 is bent at the second hinge assembly 144. The joint formed by the tension springs of the second hinge assembly 144 is configured such that the left temple 112 crosses over the frame 132 of the reading glasses 100. The proximal end 138 of the left temple 112 is configured at a lower left side 202 of the frame 132 of the reading glasses 100. The distal end 140 of the left temple 112 is configured at the lower right side 204 of the frame 132 of the reading glasses 100. Thus, the right lens 106 and left lens 108 are protected from rubbing or scrapping surfaces by the position of the right temple 110 and the left temple 112 effectively creating a self-made case for the reading glasses 100.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An apparatus for reading, said apparatus comprising:
a right side, said right side having a right rim;
a left side, said left side having a left rim;
a right lens, said right lens securely held by said right rim;
a left lens, said left lens securely held by said left rim;
a right temple, said right temple having a proximal end and a distal end;
a left temple, said left temple having a proximal end and a distal end;
at least one nose pad, said at least one nose pad located between said right rim and said left rim and configured to provide pressure on said nose and secure said apparatus in place;
a bridge, said bridge located between said right rim and said left rim and configured to securely couple said right rim and said left rim;
a right temple, said right temple coupled to said right side and having a proximal end and a distal end;
a left temple, said left temple coupled to said left side and having a proximal end and a distal end;
wherein said right temple is coupled to said right side by a first hinge assembly;
wherein said left temple is coupled to said left side by a second hinge assembly;
wherein a joint formed by said first hinge assembly is configured such that said right temple crosses over said first lens and said second lens of said apparatus;
wherein a joint formed by said second hinge assembly is configured such that said left temple crosses over said first lens and said second lens of said apparatus;
wherein said proximal end of said left temple is configured at a lower left side of a frame of said apparatus; and
wherein said distal end of said left temple is configured at a lower right side of a frame of said apparatus.

2. The apparatus of claim 1, wherein said right lens is a made of glass.

3. The apparatus of claim 1, wherein said right lens is made of plastic.

4. The apparatus of claim 1, wherein said right lens is a first bifocal lens.

5. The apparatus of claim 1, wherein said right lens is rectangular in shape.

6. The apparatus of claim 1, wherein said left lens is a made of glass.

7. The apparatus of claim 1, wherein said left lens is made of plastic.

8. The apparatus of claim 1, wherein said left lens is a first bifocal lens.

9. The apparatus of claim 1, wherein said left lens is rectangular in shape.
